(19) United States
(12) Patent Application Publication
(10) Pub. No.: US 2026/0024322 A1
(43) Pub. Date: Jan. 22, 2026

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: Yasuhiro OKUNO, Tokyo (JP)

(21) Appl. No.: 19/265,493

(22) Filed: Jul. 10, 2025

(30) Foreign Application Priority Data
Jul. 17, 2024 (JP) 2024-114188

(51) Int. Cl. G06V 10/776; G06V 10/764; G06V 10/82; G06V 40/16

(52) U.S. Cl. CPC G06V 10/776; G06V 10/764; G06V 10/82; G06V 40/172; G06V 2201/07

(57) ABSTRACT

An information processing apparatus that detects a subject from an input image, the information processing apparatus comprising: a storage unit that stores a fixed model that is a non-changeable recognition model learned so as to detect a subject of a predetermined category and a custom model that is a customizable recognition model learned so as to detect a subject in an identical category to the fixed model; a setting unit that sets an integration method of a detection result using the fixed model and a detection result using the custom model; and an integration unit that acquires an integration detection result by integrating, based on the integration method, each detection result to the input image.

### BACKGROUND

### Field of the Technology

The present disclosure relates to an information processing apparatus, a control method of an information processing apparatus, and a storage medium.

### Description of the Related Art

Object detection of detecting a region of a specific object from an image is performed. For example, face detection of detecting a face region of a person from an image of the person as a subject is performed. Based on a result of face detection, face authentication, autofocus processing at the time of capturing, and the like are performed.

As a technique of object detection, in recent years, a technique of learning a recognition model using a neural network has been developed. CenterNet: Keypoint Triplets for Object Detection, Kaiwen Duan, Song Bai, Lingxi Xie, Honggang Qi, Qingming Huang, Qi Tian; ICCV2019, pp. 6569-6578 discloses a method for detecting an object by learning a neural network so as to output, as a heat map, a key point indicating an object position of a detection target.

There is a case where the neural network learned once is additionally learned in accordance with data obtained at the operation site. Japanese Patent No. 7271306 discloses a method of learning an inspection apparatus by a neural network, performing additional learning by additional data collected during operation of the inspection apparatus, and updating the neural network. This “additional learning” is sometimes called, for example, Fine Tuning. As disclosed in Japanese Patent No. 7271306, if there is a subject difficult to be detected at the operation site, the recognition accuracy of the subject can be improved by collecting image data thereof and performing additional learning.

For example, if the detection accuracy of a specific person is low in face detection, it can be expected that the person can be accurately detected by performing additional learning of a recognition model using an image of the person. Specifically, camera manufacturers learn a detector (recognition model) of a subject for autofocus and sell and provide camera products incorporating the detector, and there may be a case where users perform additional learning of the detector according to their own preferences.

However, if the recognition model is updated by additional learning, there is a case where recognition successful before the additional learning no longer succeeds. For example, in face detection, additional learning of a specific person can destabilize detection of another person successfully detected with the recognition model before performing additional learning.

### SUMMARY

The present disclosure has been made in view of the above problems, and provides a technique for enabling, by additional learning, detection of a subject desired by a user while maintaining detection performance before performing additional learning.

According to one aspect of the present disclosure, there is provided an information processing apparatus that detects a subject from an input image, the information processing apparatus comprising: a storage unit that stores a fixed model that is a non-changeable recognition model learned so as to detect a subject of a predetermined category and a custom model that is a customizable recognition model learned so as to detect a subject in an identical category to the fixed model; a setting unit that sets an integration method of a detection result using the fixed model and a detection result using the custom model; and an integration unit that acquires an integration detection result by integrating, based on the integration method, each detection result to the input image.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a configuration diagram of an information processing apparatus according to a first embodiment.

FIGS. 2A and 2B are explanatory diagrams of a recognition model and detection processing according to the first embodiment.

FIG. 3 is a flowchart of a flow of overall processing according to the first embodiment.

FIG. 4 is an explanatory diagram of processing of a learning setting unit according to the first embodiment.

FIG. 5 is a flowchart showing a procedure of processing executed by a false detection verification unit according to the first embodiment.

FIG. 6 is a flowchart showing a procedure of processing executed by a custom model registration unit according to the first embodiment.

FIG. 7 is an explanatory diagram illustrating a procedure of processing executed by an integration method setting unit according to the first embodiment.

FIG. 8 is a flowchart showing a procedure of processing executed by a detection unit according to the first embodiment.

FIG. 9 is a flowchart showing a procedure of processing executed by a detection result integration unit according to the first embodiment.

FIG. 10 is an explanatory diagram of an integration detection result according to the first embodiment.

FIG. 11 is a flowchart showing a procedure of processing executed by a display control unit according to the first embodiment.

FIG. 12 is an explanatory diagram of a multi-task recognition model according to a second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

Hereinafter, the first embodiment of the present disclosure will be described with reference to the drawings. The recognition model in the following embodiment will be described as a recognition model that performs object detection of detecting a subject of a predetermined category. The category is a classification of a detection target. For example, a face region of a person or an entire body region of an animal is a category of a detection target. As a recognition model, a separate model is learned for each category of the detection target. In the present embodiment, an example in which a user performs additional learning using additional data regarding a desired subject for a recognition model learned in advance will be described. This is an example in which the user who purchases a camera released as a product by a camera manufacturer performs additional learning for a recognition model originally included in the camera to have improved detection accuracy of the subject desired by the user. Note that this embodiment is described as an example of carrying out the present disclosure, and the present disclosure is not limited to this example.

### Configuration of Information Processing Apparatus

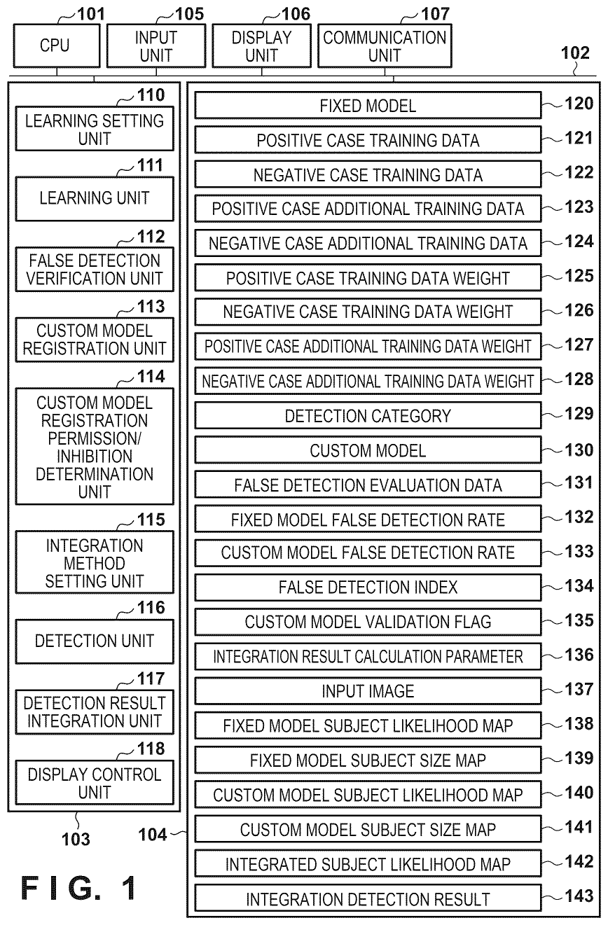

FIG. 1 is a configuration diagram of an information processing apparatus according to the present embodiment. A CPU 101 controls the entire information processing apparatus. A first memory 103 and a second memory 104 are storage units that store control programs and various data for performing processing according to the present embodiment. Here, it is described that the first memory 103 mainly stores control programs and the second memory 104 mainly stores various data, but the present disclosure is not limited to this.

An input unit 105 includes a keyboard, a mouse, and a touch panel, and receives input from the user. A display unit 106 includes a display apparatus such as a liquid crystal display, and can display a processing result to the user. A communication unit 107 can communicate with an external apparatus to transmit and receive data. The above components are connected via a computer bus 102. The information processing apparatus according to the present embodiment can be carried out as a computer including, as a program, each processing unit described below. Certain parts of the above-described configuration may each be configured to be included in a different computer and to perform processing by communicating with one another via the communication unit 107 included in each computer. For example, a processing unit related to learning and evaluation of the recognition model may be provided in a computer on a cloud, and a detection unit, a display unit, and the like that use the recognition model may be provided on an edge device such as a camera or a smartphone.

The memory 104 stores a fixed model 120 in advance. This is a recognition model learned to detect a subject of a predetermined category, and is learned using a neural network, for example. The learning is performed such that a region of the subject of the predetermined category can be detected by inputting an image to the recognition model.

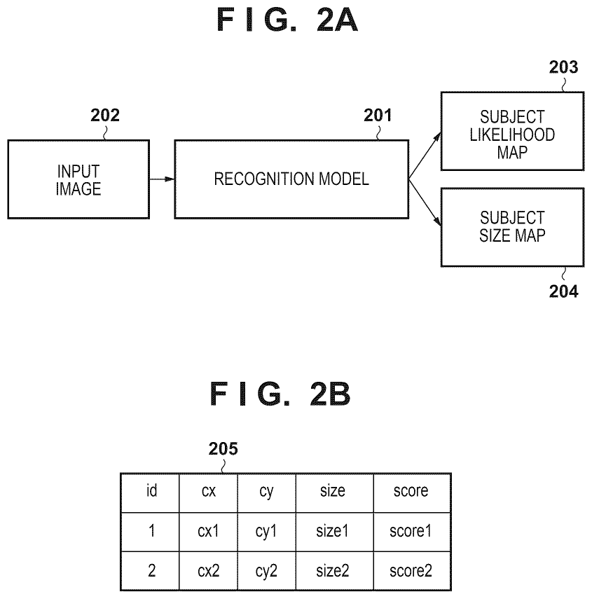

Here, FIGS. 2A and 2B are diagrams describing an example of the operation of a recognition model that performs object detection. As illustrated in FIG. 2A, the learning is performed such that a subject likelihood map 203 and a subject size map 204 are output when an input image 202 is input to a recognition model 201. The recognition model 201 is, for example, a neural network.

The subject likelihood map 203 is a map representing likelihood in which a subject of a predetermined category is estimated to be present at each position on the image. On the subject likelihood map 203, an independent region (blob) having a map value of a predetermined value or more is extracted, a position at which the map value is maximum in each region is calculated, and the center of the subject is present at the position. A map value of the subject likelihood map 203 at the center position is a detection score of the detection.

The subject size map 204 is a map in which a value in which the size of the subject for each position on the image is estimated is output as a map value. The map value of the subject size map 204 corresponding to the position of the subject center calculated as described above is read and assumed to be the size of the subject. Although expression of the subject size is arbitrary, for simplifying the description, in the present embodiment, the subject size is a square, and the subject size map 204 is a map for estimating the side length of the square.

In this case, a detection result for one subject is expressed by a bounding box represented by a set of center coordinates and a size value of the subject. Since a plurality of subjects may exist on one image, the detection result for one image is a list of bounding boxes and is as in a table of a detection result 205 shown in FIG. 2B. In the table, id is an identifier of the subject detected on the image, cx is an x coordinate of the subject center, cy is a y coordinate of the subject center, size is a subject size, and score is a detection score. This is an example in which two subjects are detected. The detection result having id of 1 is a region having the center coordinates of (cx1, cy1) and having size of size1, and the detection score is score1. The detection result having id of 2 is a region having the center coordinates of (cx2, cy2) and having size of size2, and the detection score is score2.

Note that the above example is an example of a method of performing object detection, and the present disclosure is not limited to this. For example, the expression of the subject size may have a long side and a short side of a rectangle surrounding the subject, and learning may be performed so as to output two of a long side size map and a short side size map as the subject size map 204. The method may be a method of not performing learning so as to output the region where the subject exists as the subject likelihood map or the subject size map but performing learning so as to directly infer the value of the bounding box of the subject, for example.

The memory 104 of FIG. 1 stores positive case training data 121 and negative case training data 122. This is prepared in advance as data for learning the recognition model. For example, training data used when the fixed model 120 is learned may be used. In the present embodiment, since the recognition model for performing object detection is taken as an example, training data including an image of the subject of the detection target and a value of a bounding box representing the region to be detected is prepared. The negative case training data 122 is data of collection of cases prone to false detection in the category of the detection target. These training data are used when detection of a predetermined category is learned. Although different data from each other is prepared for each category of the detection target, for simplification in the present embodiment, it is illustrated that data for one category is stored.

The memory 104 stores positive case additional training data 123 and negative case additional training data 124. These additional training data store training data regarding a desired subject that the user desires to perform additional learning in detection of a predetermined category. Here, the negative case additional training data 124 is not essential and may be empty. This is because, when the user performs additional learning of a case for which the detection accuracy is desired to be improved, the number of patterns of cases prone to false detection in the predetermined category does not increase, and therefore, in many cases, it is sufficient to perform learning using the negative case training data 122 prepared in advance. These additional training data are created by the user in advance and stored in the memory 104.

### Processing

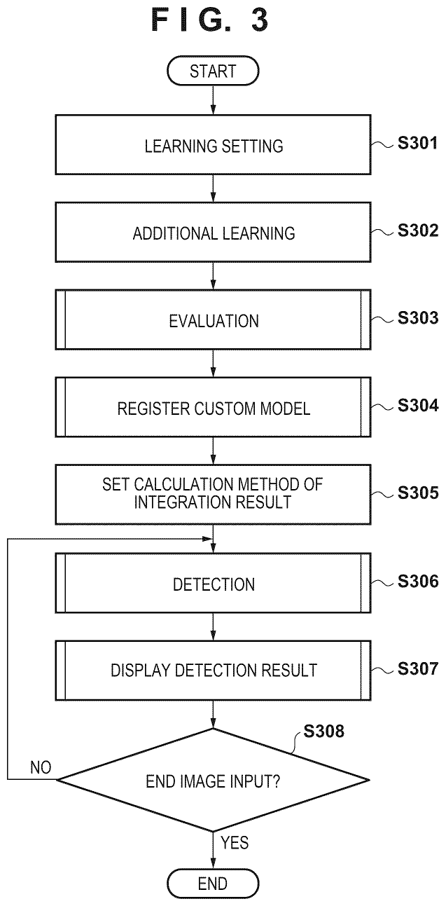

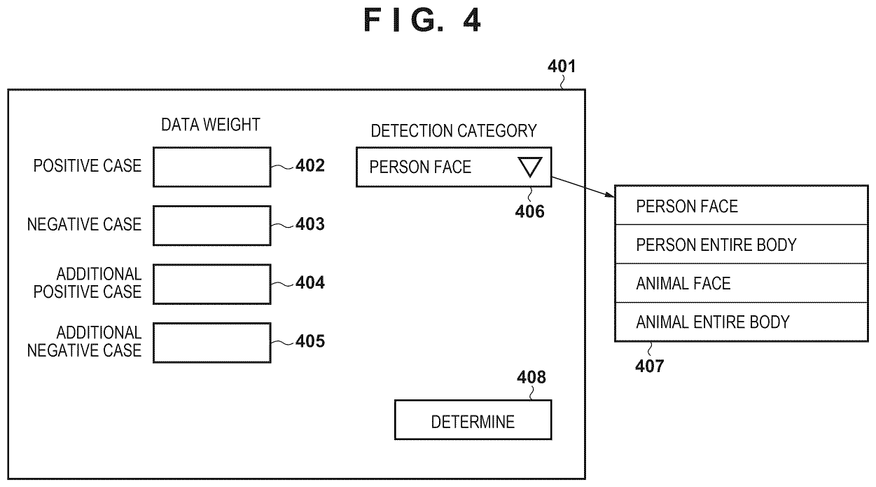

FIG. 3 is a flowchart describing an overall flow of the processing according to the first embodiment. In S301, a learning setting unit 110 performs setting of additional learning based on a user operation. Here, FIG. 4 is a diagram describing a user interface (UI) provided by the learning setting unit 100. The UI may be displayed on the display unit 106, and the user may perform setting via the input unit 105.

402 to 405 of FIG. 4 are parts to which numerical values designating weights of data are input. In 402, a data weight for the positive case training data 121 is set. In 403, a data weight for the negative case training data 122 is set. In 404, a data weight for the positive case additional training data 123 is set. In 405, a data weight for the negative case additional training data 124 is set. A detection category selection menu 406 is a pull-down menu, and selects and sets one from detection categories (in the illustrated example, person face, person entire body, animal face, and animal entire body) present in a detection category menu 407. When a determination button 408 is pressed, the learning setting unit 110 stores the value set by the UI into the memory 104. Regarding the weights set to 402 to 405, each set value may be divided by the sum of the values set to 402 to 405 and stored as a ratio of the data weight. Each set weight value is stored in a positive case training data weight 125, a negative case training data weight 126, a positive case additional training data weight 127, and a negative case additional training data weight 128 in the memory 104. The category set in the detection category selection menu 406 is stored in a detection category 129 in the memory 104. When the determination button 408 is pressed, the processing of the learning setting unit 110 is ended, and S301 is ended.

Note that the processing of the learning setting unit 110 is not limited to the above-described setting content, and setting content other than the above related to learning may also be settable. For example, a learning rate or data augmentation may be settable.

In S302, a learning unit 111 performs additional learning. The learning unit 111 generates a neural network having, as an initial value, the fixed model 120 corresponding to the detection category set in the detection category 129, and performs additional learning thereof. As the training data, the positive case training data 121, the negative case training data 122, the positive case additional training data 123, and the negative case additional training data 124 in the memory 104 are used. Here, also for the training data, data corresponding to the detection category set in the detection category 129 is used. As weights of the training data, the positive case training data weight 125, the negative case training data weight 126, the positive case additional training data weight 127, and the negative case additional training data weight 128 in the memory 104 are used.

A learning progress status may be configured to be presented to the user so that the user can grasp the status during learning. The positive case additional training data 123 given by the user may be divided into training data and validation data so that detection accuracy for the validation data can be presented. This enables the user to proceed with learning while confirming the detection accuracy regarding a desired subject. Similarly, it is possible to proceed with learning while presenting a false detection rate to the user. Processing regarding learning is similar to a generally performed method, and a detailed description thereof will be omitted here. An additionally learned neural network is stored as a custom model 130 in the memory 104.

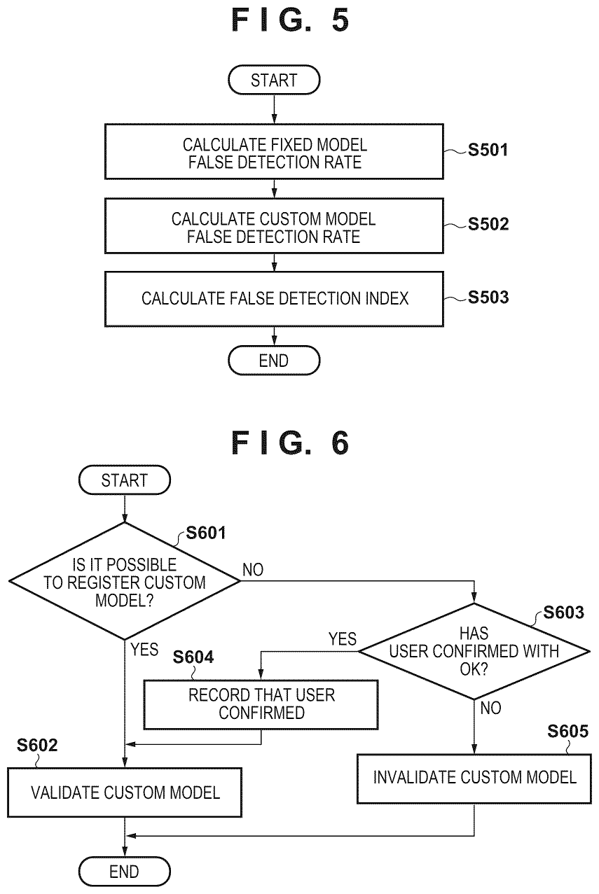

Next, in S303, a false detection verification unit 112 performs evaluation of the custom model 130. The evaluation of the model may be performed from any viewpoint, but here, in particular, a case where evaluation regarding false detection is performed using the false detection verification unit 112 will be described in detail. Here, FIG. 5 is a flowchart showing the procedure of the processing executed by the false detection verification unit 112 according to the present embodiment. Data for false detection evaluation is prepared in advance as false detection evaluation data 131 in the memory 104. The data for false detection evaluation is prepared in advance for each category set in the detection category 129. Each detection category has a picture prone to false detection, and therefore the data for false detection evaluation is evaluation data of collection of such data, for example. However, data including a positive case also includes a cause of false detection in the background, and therefore the data including the positive case may be used as the data for false detection evaluation as it is. The false detection evaluation data 131 may be configured to be further added by the user.

In S501, the false detection verification unit 112 performs detection processing on the false detection evaluation data 131 using the fixed model 120, and calculates and stores, into a fixed model false detection rate 132 in the memory 104, a false detection rate of the fixed model 120.

In S502, the false detection verification unit 112 performs detection processing on the false detection evaluation data 131 using the custom model 130, and calculates and stores, into a custom model false detection rate 133 in the memory 104, a false detection rate of the custom model 130.

In S503, the false detection verification unit 112 calculates and stores, into a false detection index 134 in the memory 104, a false detection index as an evaluation value of the custom model 130. The calculation formula of the false detection index 134 represents a relative difference of the false detection rate of the custom model from the false detection rate of the fixed model. For example, it can be calculated using the following Formula 1. The ratio of the false detection rate of the custom model to the false detection rate of the fixed model is used as the false detection index.

False detection index=Custom model false detection rate/Fixed model false detection rate (1)

Formula 1 enables the degree of false detection of the custom model to be indexed without presenting the false detection rate itself of the fixed model. That is, if the function of the false detection verification unit 112 is arranged on a cloud or the like, it is possible to conceal the false detection rate of the fixed model from the user.

Since the false detection rate of the fixed model may be a trade secret of a camera manufacturer, concealing is effective. This false detection index may be calculated for the model being learned also during additional learning and presented to the user during the learning. This enables the user to grasp whether the learning is progressing well.

This is the end of the processing of S303 in FIG. 3. The processing from S301 to S303 is processing for additional learning, and these may be performed not by an apparatus that performs detection processing described later but by the computer on the cloud, for example.

In S304, a custom model registration unit 113 registers, as a valid recognition model for detection, the custom model 130 that is additionally learned. Note that one or more custom models may be registered for one detection category.

Here, FIG. 6 is a flowchart showing the procedure of the processing executed by the custom model registration unit 113 according to the present embodiment. In S601, a custom model registration permission/inhibition determination unit 114 determines whether or not to register the custom model 130 as valid based on a verification result of the false detection verification unit 112. For example, the registration permission/inhibition determination unit 114 determines permission/inhibition of registration by determining the false detection index 134 in the memory 104 is a value lower than a predetermined value determined in advance. The registration permission/inhibition determination unit 114 determines that the registration is possible when the false detection index 134 is a value lower than the predetermined value. Note that the processing of the registration permission/inhibition determination unit 114 here is an example, and various evaluations such as accuracy evaluation regarding truc detection may be performed, and permission/inhibition of registration may be determined based on the results. If the present step is yes, the process proceeds to S602. On the other hand, if the present step is no, the process proceeds to S603.

In S602, the custom model registration unit 113 validates the custom model by turning on a custom model validation flag 135 in the memory 104. Thereafter, the process is ended.

In S603, the custom model registration unit 113 notifies the user that the false detection index is high, and requests that the user confirm whether to still register the custom model as valid. For example, a dialog for confirmation may be presented to the user, and the intention of the user may be confirmed by causing the user to press an OK button (or a registration button) or a cancel button in the dialog. If the present step is yes, the process proceeds to S604. On the other hand, if the present step is no, the process proceeds to S605.

In S604, the custom model registration unit 113 records information indicating that the user has registered the custom model after confirming that the false detection index is high, and proceeds to S602 to validate the custom model. In S605, the custom model registration unit 113 invalidates the custom model. That is, the custom model validation flag 135 in the memory 104 is turned off. Note that in a case where additional learning of the custom model has been performed in another apparatus in advance, an additionally learned custom model may be acquired from the other apparatus via the communication unit 107 only in a case where the custom model is validated in S602.

This is the end of description of the processing of the custom model registration unit 113 in S304 of FIG. 3.

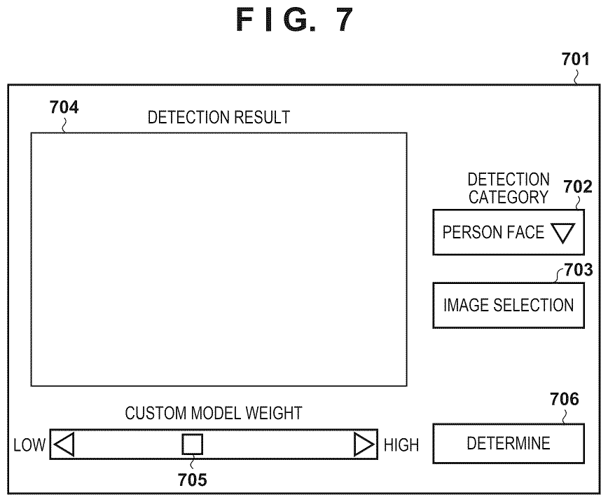

Subsequently, in S305, an integration method setting unit 115 sets an integration method of a detection result. Here, FIG. 7 is a diagram describing the operation of the integration method setting unit 115 according to the present embodiment.

701 is an example of a UI screen presented to the user by the integration method setting unit 115. For example, a UI is configured to be displayed on a display of a camera so as to enable the user to change setting content by using a setting button or the like of the camera. Alternatively, setting may be performed by a computer or the like, and the setting result thereof may be stored in the camera.

702 is a detection category selection menu, and is a pull-down menu similar to the detection category selection menu 406 illustrated in FIG. 4. The user selects a category of a detection target from the detection category selection menu 702.

703 is an image selection button. When the image selection button 703 is pressed, a dialog (not illustrated) for image selection is displayed, and the user can select an image. A detection unit 116 described later performs detection of the subject for the selected image, and a display control unit 118 displays a detection result on a screen 704. When this processing is performed by the camera, an image may be selected from images stored in the memory of the camera, or an image photographed live by an image capturing unit of the camera may be used.

705 is a slider bar for setting the weight of the custom model. The user adjusts the slider bar 705 while confirming the detection result displayed on the screen 704 for the desired image. For example, the result of detection by the fixed model is displayed as a red detection frame, and the result of detection by the custom model is displayed as a yellow detection frame. When the position of the slider bar 705 is operated, the number of yellow detection frames indicating the result of detection by the custom model changes. For example, when the weight is increased, the display of the yellow detection frame due to false detection increases. The user operates the slider bar 705 so that there is no false detection by the custom model and the subject is correctly detected. The value set by the slider bar 705 is stored in an integration result calculation parameter 136 in the memory 104. This parameter is a parameter used by a detection result integration unit 117 described later for processing of integrating the detection result from the fixed model and the detection result from the custom model. Details of this parameter will be described later.

706 is a determination button. When the determination button 706 is pressed, the processing of the integration method setting unit 115 is ended.

Subsequently, in S306, the detection unit 116 performs detection processing. An example of the detection processing is, for example, processing of performing detection of the subject using a recognition model for images sequentially acquired in a camera or a video camera. Details of the processing of the detection unit 116 will be described later.

In S307, the display control unit 118 displays the detection result obtained in S306. This is processing of displaying the result detected by the detection unit 116 onto the display unit 106 or the like. Details of the processing of the display control unit 118 will be described later.

In S308, the detection unit 116 determines whether input of the image to be detected has been completed. In a camera or a video camera, it is common to continuously perform input of images of the detection target, and repeatedly perform processing of detection. When input of the image to be detected is completed, the process is ended. On the other hand, when input of the image to be detected is not completed, the process returns to S306, and the detection and the display of the detection result are repeated.

Note that in the above-described description, for simplifying the description, the processing regarding additional learning and the processing regarding detection are collectively described as a series of processing, but the present disclosure is not limited to this. The processing from S301 to S303 is performed by the computer on the cloud, the processing from S304 to S305 is performed by the camera, and regarding the processing in and after S306, only in this part may be configured to be repeatedly performed every time image capturing is performed by the camera. For example, when the detection result is used for autofocus (AF), the processing of S306 and S307 may be configured to be repeated while the user half-presses the shutter button of the camera. The above is the flow of overall processing of the present embodiment.

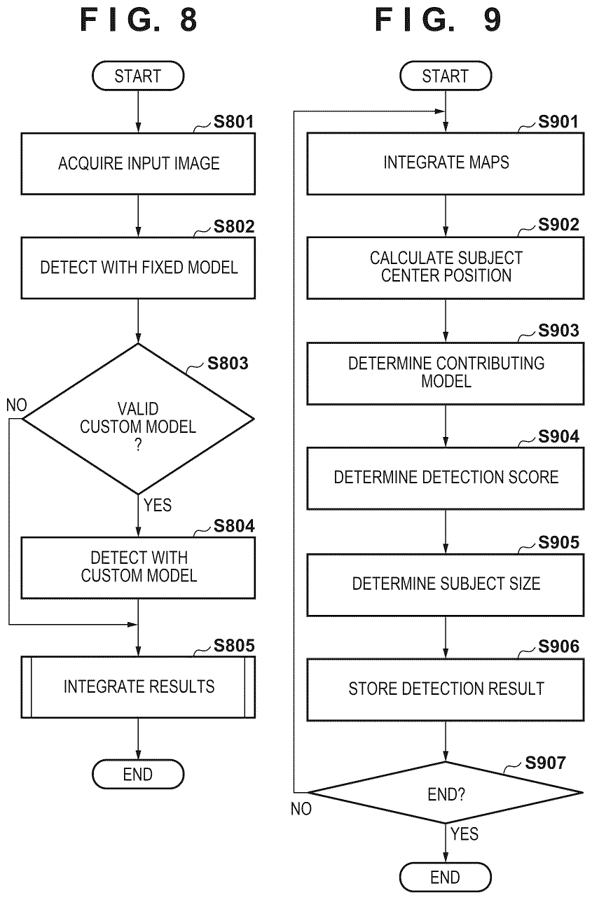

Next, details of the processing of the detection unit 116 in 306 of FIG. 3 will be described. FIG. 8 is a flowchart showing the procedure of the processing executed by the detection unit 116 according to the present embodiment.

In S801, the detection unit 116 acquires an input image and stores it into an input image 137 in the memory 104. The input image 137 may be acquired by capturing using the image capturing unit (not illustrated) of the camera, may be acquired by designating an image stored in the memory in advance, or may be acquired from an external apparatus via the communication unit 107.

In S802, the detection unit 116 inputs the input image 137 to the fixed model 120 in the memory 104 and performs detection of the subject. As described with reference to FIGS. 2A and 2B, when an image is input to the recognition model, a subject likelihood map and a subject size map are obtained. The obtained maps are stored in a fixed model subject likelihood map 138 and a fixed model subject size map 139, respectively, in the memory 104.

In S803, the detection unit 116 determines whether the custom model is valid. This may be done by confirming whether the custom model validation flag 135 in the memory 104 is ON. If the custom model validation flag 135 is ON, the custom model can be determined to be valid. If the custom model is determined to be valid, the process proceeds to S804. On the other hand, if the custom model is determined not to be valid, the process proceeds to S805.

In S804, the detection unit 116 inputs the input image 137 to the custom model 130 in the memory 104 and performs detection of the subject. As described with reference to FIGS. 2A and 2B, when an image is input to the recognition model, the subject likelihood map and the subject size map are obtained. The obtained maps are stored in a custom model subject likelihood map 140 and a custom model subject size map 141, respectively, in the memory 104.

Note that if the custom model is determined in S803 not to be valid, 0 may be set and stored to each map value of the custom model subject likelihood map 140 and the custom model subject size map 141 before the processing of S805 is performed. When one or more custom models are registered for a predetermined category, a similar processing to that in S804 may be repeated for the number of custom models. In that case, the custom model subject likelihood map 140 and the custom model subject size map 141 are managed separately for the respective custom models.

In S805, the detection result integration unit 117 integrates the result of detection by the fixed model 120 and the result of detection by the custom model 130 into one. Details of the processing of the detection result integration unit 117 will be described later. This is the end of the processing of FIG. 8.

Next, details of the processing of the detection result integration unit 117 in S805 of FIG. 8 will be described. Here, FIG. 9 is a flowchart showing the procedure of the processing executed by the detection result integration unit 117 according to the present embodiment.

In S901, the detection result integration unit 117 integrates the fixed model subject likelihood map 138 and the custom model subject likelihood map 140 in the memory 104 into one map by the following Formula 2, for example, and calculates an integrated subject likelihood map.

Integrated subject likelihood map=max(Fixed model subject likelihood map,custom model subject likelihood map*α) (2)

Here, the max function is a function that calculates a map value having a maximum value at each position of the map. The coefficient α is a scalar value, and if the custom model validation flag in the memory 104 is ON, the integration result calculation parameter 136 in the memory 104 is used as the coefficient α. If the custom model validation flag in the memory 104 is OFF, the value of the coefficient α may be 0. The calculated integrated subject likelihood map is stored in an integrated subject likelihood map 142 in the memory 104.

Note that the calculation method of the integrated subject likelihood map indicated by the above Formula 2 is not limited to this. For example, as another example, it is also possible to perform calculation using the following Formula 3.

Integrated subject likelihood map=Fixed model subject likelihood map+(Custom model subject likelihood map*β) (3)

Formula 3 represents that the integrated subject likelihood map is obtained by calculating the weighted sum of the fixed model subject likelihood map and the custom model subject likelihood map at each position on the map. The coefficient β is a weight value of the weighted sum. Detection can be performed by adding the map value of the custom model subject likelihood map to the subject not detected because the map value of the subject likelihood map is insufficient in the detection processing using only the fixed model. Depending on the setting of the coefficient β, the behavior of true detection and false detection caused by the custom model varies. The coefficient β may be set by operating the slider bar 705 illustrated in FIG. 7. On the UI screen illustrated in FIG. 7, an option as to which of Formula 2 and Formula 3 described above to use may be displayed so that the user can select the option.

Note that in the present embodiment, the calculation method of the integrated subject likelihood map is arbitrary, but both of the above-described calculation methods of the integrated subject likelihood map by Formula 2 and Formula 3 are methods ensuring that the subject detected only by the fixed model 120 is always detected. This is because using the methods of Formula 2 and Formula 3, the map value at each position of the integrated subject likelihood map 142 will not be smaller than the map value of the fixed model subject likelihood map 138.

This configuration can improve the detection performance for the desired subject additionally learned by the user without reducing the detection performance by the fixed model 120. When the fixed model 120 is a recognition model provided by a camera manufacturer, detection performance intended by the camera manufacturer is ensured, and only the detection performance is increased by user customization.

However, when integration is performed by such a method, too many false detections in the custom model result in many false detections also in an integration detection result. In order to avoid this, in the processing of evaluation of the custom model in S303 of FIG. 3, evaluation is performed using the false detection verification unit 112 with special attention not only to the performance on the true detection side but also to the performance on the false detection side.

In Formula 3, the coefficient β may be configured to be set negative. In this case, detection is suppressed in a region where the map value of the custom model subject likelihood map 140 is high. The user may perform additional learning using, as the positive case additional training data 123, data of the subject not desired to detect. This configuration enables the custom model 130 to be used in order to avoid false detection to a specific subject by the fixed model 120. In this case, detection by the fixed model 120 is reduced, but in this case, it is the result in line with the user's intention.

Subsequently, in S902, the detection result integration unit 117 calculates a subject center position of a subject region using the integrated subject likelihood map 142. As described with reference to FIGS. 2A and 2B, the independent region (blob) having the map value of the predetermined value or more is extracted from the subject likelihood map output by the recognition model, and the coordinate having the maximum value in each independent region is the coordinate of the subject center position. It is possible to extract 0 to a plurality of subject center positions calculated in this manner. In and after S903, processing is performed for each of the extracted subject center positions.

In S903, the detection result integration unit 117 determines a recognition model having contributed to detection of one of the subject center positions calculated in S902. The detection result integration unit 117 compares the map value of the fixed model subject likelihood map 138 at the subject center position with the map value of the custom model subject likelihood map 140. Then, the detection result integration unit 117 determines the model having the larger map value as a contribution model at the subject center position based on the comparison result. For example, when the map value of the fixed model subject likelihood map 138 is larger than the map value of the custom model subject likelihood map 140 at the subject center position, it is determined that the contribution model is the fixed model.

In S904, the detection result integration unit 117 determines a detection score. The map value at the subject center position on the subject likelihood map output by the contribution model determined in S903 is the detection score.

In S905, the detection result integration unit 117 determines a subject size. The map value at the coordinate of the subject center position is read from the size map of the determined contribution model, and is used as the size value of the subject size. For example, when the contribution model is a fixed model, the map value of the coordinate of the subject center position in the fixed model subject size map 139 is used as the size value of the subject size.

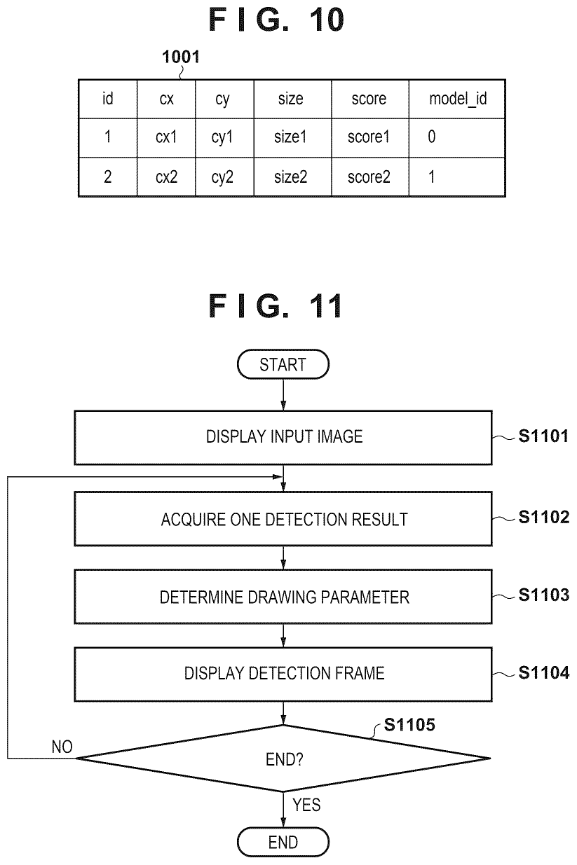

In S906, the detection result integration unit 117 additionally stores, into an integration detection result 143 of the memory 104, a set of values further including an identification ID indicating the type of the contribution model in addition to a coordinate value of the subject center position, a subject size value, and a detection score value calculated by these processing. The integration detection result 143 includes information such as Table 1001 shown in FIG. 10, for example. The information indicated by the detection result 205 in FIGS. 2A and 2B is added with a term of model_id representing the contribution model. For example, model_id being 0 may indicate detection by a fixed model, and model_id being 1 may indicate detection by a custom model. In the example of FIG. 10, two integrated detection results are stored.

In S907, the detection result integration unit 117 determines whether or not the processing is completed for all the independent regions (blobs) of the one or more independent regions (blobs) extracted in S902. If the present step is no, the process returns to S903 and repeats the processing. On the other hand, if the present step is yes, the series of process is ended.

Note that in the above-described description, an example in which detection results are integrated in a form in which each recognition model outputs a likelihood map and a size map has been described, but the present disclosure is not limited to this. For example, a recognition model learned so as to directly infer the parameter of the bounding box of the detected subject may be used. In that case, the bounding boxes output from the fixed model and the custom model may be integrated into one based on the degree of overlap between the regions. For the bounding boxes overlapping by a certain proportion or more, the values of the position, the size, and the detection score may be averaged and integrated into one. When the contribution model is determined, a model having a larger degree of overlap with the integrated bounding box may be determined as the contribution model. This is the end of description of the processing of the detection result integration unit 117.

Next, details of the processing of the display control unit 118 that performs the detection result display processing in S307 of FIG. 3 will be described. This is processing of displaying, onto the display unit 106, the integration detection result 143 in the memory 104. The display unit 106 may be a display connected to a computer, a display attached to a camera, a display unit of a smartphone, or the like.

The display control unit 118 may display the input image 137 and superimpose, as a rectangular frame, a bounding box represented by the integration detection result 143 on the input image 137. At this time, a drawing method of the display frame may be distinguished and displayed based on model_id of the integration detection result 143. Another color or another line type may be used based on model_id, for example. This enables the user to easily grasp as to which recognition model has detected each detection result. That is, the user can easily grasp how the detection performance by only the fixed model is improved by registering the custom model.

When the number of false detections increases due to registration of the custom model, the user can easily grasp whether the false detections are due to the fixed model or due to the custom model. For example, it is possible for the user to grasp that the number of false detections increases due to registration of the custom model while using the camera, it is possible to make a selection such as unregistering the custom model. In order to unregister the custom model, processing of turning off the custom model validation flag 135 in the memory 104 may be performed.

Subsequently, FIG. 11 is a flowchart showing the procedure of the processing executed by the display control unit 118. In S1101, the display control unit 118 displays, onto the display unit 106, the input image 137 in the memory 104. In S1102, the display control unit 118 acquires one detection result from the integration detection result 143 in the memory 104. For example, it may be acquired in the order of id. In S1103, the display control unit 118 determines a drawing parameter based on the contribution model represented by model_id of the one detection result acquired in S1102. The drawing parameter here is a color, a line type, or the like to be drawn.

For example, when the drawing parameter is the color, drawing may be performed in red when model_id is 0, and drawing may be performed in green when model_id is 1. Alternatively, when the drawing parameter is the line type, drawing may be performed with a line type of a rectangular frame that is different depending on model_id, for example. Expression of the drawing may be distinguished by any method as long as it is distinguished based on the contribution model.

In S1104, the display control unit 118 superimposes the bounding box of the detection result on the display unit 106 in accordance with the drawing parameter (e.g., the color, the line type, or the like) determined in S1103.

In S1105, the display control unit 118 determines whether or not all the results of the integration detection result 143 have been displayed. If the present step is yes, the process is ended. On the other hand, if the present step is no, the process returns to S1102.

As described above, in the present embodiment, two models are provided, which are the fixed model that is an non-changeable recognition model learned so as to detect a subject in a predetermined category, and the custom model that is a customizable recognition model learned so as to detect a subject in the predetermined category.

Then, the integration method of the detection result using the fixed model and the detection result using the custom model (not integration of models but integration of detection results) is set. The weight may be set on the UI screen using the above-described slider bar or the like, or the weight may be received and set from another apparatus. Then, the detection results are integrated based on the set integration method, and the integration detection result is acquired and displayed.

According to the present embodiment, since model integration between the fixed model and the custom model is not performed but detection results obtained from the respective models are integrated, it is possible to additionally detect, by additional learning, a subject desired by a user while maintaining detection performance before performing additional learning. Therefore, the user can freely perform customization while ensuring the detection performance provided by the camera manufacturer.

Note that in the present embodiment, a configuration in which each processing unit and memory are arranged in one information processing apparatus has been described, but the present disclosure is not limited to this. For example, a processing unit related to learning and a memory may be arranged in a computer on a cloud, and a processing unit related to setting, detection, and display of an integration method may be arranged on the camera. With this configuration, it is possible to conceal, from the user, data prepared in advance such as the positive case training data 121 and the negative case training data 122 and details of the learning processing.

A camera manufacturer may adjust processing inside the camera in expectation of accuracy of a detection result of the fixed model 120 for a specific category. On the other hand, a case where the user desires to additionally learn a desired subject in a person face detection category in order to easily autofocus the desired subject is considered. In such a case, there can be an occurrence that a person face detection result is actually used in processing other than autofocus in the camera, the detection accuracy changes due to registration of the custom model, and processing unintended by the camera manufacturer is performed.

On the other hand, in predetermined processing implemented by the camera manufacturer, the custom model validation flag 135 may be temporarily turned off to perform the detection processing. This makes it possible to obtain a detection result as expected in advance by the camera manufacturer. According to the configuration of the present embodiment, by changing the custom model validation flag 135 in the memory 104, it is possible to easily switch between the case of using the custom model and the case of not using the custom model for detection.

### Second Embodiment

In the first embodiment, an example in which the recognition model detects the subject of one category in one model has been described. The fixed model 120 and the custom model 130 have been described as being treated individually as recognition models as illustrated in the recognition model 201 of FIGS. 2A and 2B. In the second embodiment, an example in which the recognition model is a multi-task model that detects subjects of a plurality of categories by one model will be described. Furthermore, an example in which the fixed model and the custom model are a part of one multi-task model will also be described.

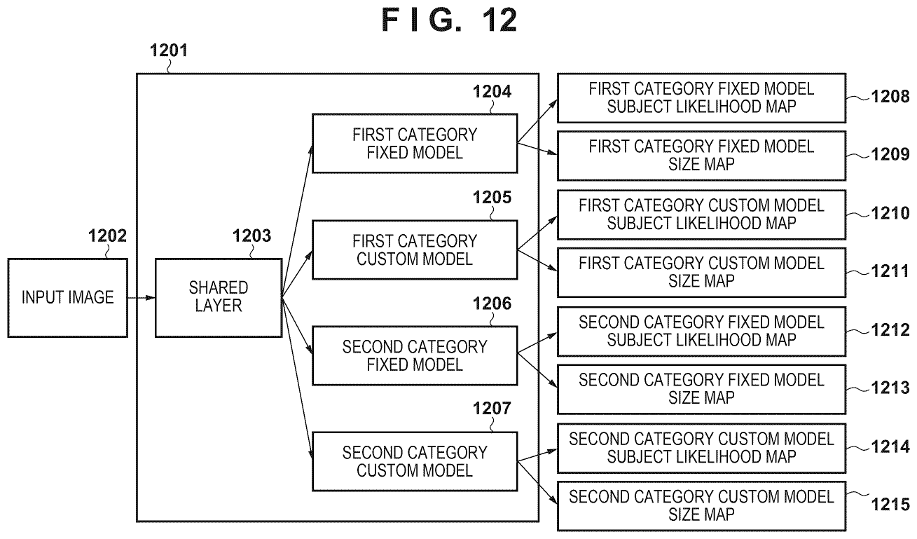

FIG. 12 is a diagram describing a recognition model that is a multi-task model according to the present embodiment. A multi-task recognition model 1201 is learned so as to perform, with one recognition model, detection of subjects of two types of categories of a first category and a second category. For example, with the face of a person being the first category and the pupil of the face of the person being the second category, learning is performed such that face detection of the person and pupil detection of the person are simultaneously performed with one recognition model.

Of course, the category is not limited to this, and learning may be performed so as to detect the entire body of a person and the entire body of an animal. The number of categories is not limited to two, and may be many. A plurality of custom models may be registerable for one category. An input image 1202 is input to the multi-task recognition model 1201.

The multi-task recognition model 1201 includes a shared layer 1203, and a fixed model and a custom model of each category. A subject likelihood map and a subject size map are output from the fixed model and the custom model, respectively, of each category. In the example of FIG. 12, a first category fixed model 1204, a first category custom model 1205, a second category fixed model 1206, and a second category custom model 1207 are provided.

Then, a first category fixed model subject likelihood map 1208 and a first category fixed model size map 1209 are output from the first category fixed model 1204. A first category custom model subject likelihood map 1210 and a first category custom model size map 1211 are output from the first category custom model 1205. A second category fixed model subject likelihood map 1212 and a second category fixed model size map 1213 are output from the second category fixed model 1206. A second category custom model subject likelihood map 1214 and a second category custom model size map 1215 are output from the second category custom model 1207.

Note that the shared layer 1203 is learned simultaneously when the fixed model is learned, and is stored in the memory in advance. The shared layer 1203 may be configured to be further subdivided and partially shared. Such an example is common in a multi-task model using a neural network, and thus detailed description thereof will be omitted here.

In the present embodiment, the learning unit 111 additionally learns only the custom model part corresponding to the detection category 129 set by the learning setting unit 110. For example, if the category indicated by the detection category 129 is the first category, only the first category custom model 1205 is learned. Of course, custom models of a plurality of categories may be additionally learned by repeating the processing.

Each processing unit described in the first embodiment performs processing separately for each category. The memory necessary for the processing may also be managed separately for each category. For example, since the custom model registration unit 113 may register only the custom model regarding the category indicated by the detection category 129, registration processing only for the custom model part of the category in the recognition model 1201 may be performed. The display control unit 118 may display the detection result separately for each category.

This configuration can simultaneously perform detection of a large number of categories with a smaller memory amount and a smaller calculation amount than those when individually holding a model for each category desired to detect. The range of learning in additional learning of the custom model is limited, and therefore the learning of the custom model is stabilized and the memory amount and the calculation amount necessary for the learning can also be reduced. Furthermore, registration of the custom model for a certain category does not affect a detection result of another category.

According to the present disclosure, it is possible to additionally detect, by additional learning, a subject desired by a user while maintaining detection performance before performing additional learning.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-114188, filed Jul. 17, 2024, which is hereby incorporated by reference herein in its entirety.

What is claimed is:

1. An information processing apparatus that detects a subject from an input image, the information processing apparatus comprising:
a storage unit that stores a fixed model that is a non-changeable recognition model learned so as to detect a subject of a predetermined category and a custom model that is a customizable recognition model learned so as to detect a subject in an identical category to the fixed model;
a setting unit that sets an integration method of a detection result using the fixed model and a detection result using the custom model; and
an integration unit that acquires an integration detection result by integrating, based on the integration method, each detection result to the input image.

2. The information processing apparatus according to claim 1 further comprising a learning unit that performs learning of the custom model by additional learning with the fixed model as an initial value.

3. The information processing apparatus according to claim 2 further comprising a learning setting unit that performs setting of the learning unit, wherein the setting includes setting of weighting between positive case training data including data of the predetermined category and negative case training data not including data of the predetermined category.

4. The information processing apparatus according to claim 1 further comprising
a display control unit that causes a display unit to display the integration detection result, wherein
the display control unit distinguishes a detection result obtained using the fixed model and a detection result obtained using the custom model, and causes the integration detection result to be displayed.

5. The information processing apparatus according to claim 1, wherein the integration method is a method of not reducing a detection result of the fixed model.

6. The information processing apparatus according to claim 1, wherein the integration method is a method of adding a detection result of the custom model to a detection result of the fixed model.

7. The information processing apparatus according to claim 1, wherein the integration unit extracts one or more independent regions having a map value of a predetermined value or more from a subject likelihood map output from each of the fixed model and the custom model, and acquires, as a subject center position, a coordinate having a maximum value in each independent region.

8. The information processing apparatus according to claim 1, wherein
the setting unit sets a weight for integrating a detection result using the fixed model and a detection result using the custom model, and
the integration unit acquires, as the integration detection result, a weighted sum of a detection result using the fixed model and a detection result using the custom model based on the weight set by the setting unit.

9. The information processing apparatus according to claim 8, wherein the setting unit presents, to a user, a screen for receiving an input of the weight, and sets the weight input from the user as a weight for integrating a detection result using the fixed model and a detection result using the custom model.

10. The information processing apparatus according to claim 9, wherein the screen includes a slider bar for receiving an input of the weight.

11. The information processing apparatus according to claim 8, wherein the weight is a weight of a detection result using the custom model with respect to a detection result using the fixed model.

12. The information processing apparatus according to claim 1 further comprising
a verification unit that performs false detection evaluation of the custom model, wherein
the verification unit acquires, as an evaluation value of the custom model, a false detection index indicating a difference in a false detection rate of the custom model from a false detection rate of the fixed model, and performs the false detection evaluation based on the evaluation value.

13. The information processing apparatus according to claim 12 further comprising a determination unit that determines permission/inhibition of registration of the custom model based on a verification result of the verification unit.

14. The information processing apparatus according to claim 1, wherein the custom model is a recognition model in which a user performs additional learning of a subject not desired to detect, and
the integration method is a method of reducing a detection result of the fixed model.

15. The information processing apparatus according to claim 1, wherein
the fixed model includes a plurality of fixed models respectively corresponding to a plurality of categories, and
the custom model includes a plurality of custom models respectively corresponding to the plurality of categories.

16. A control method of an information processing apparatus that detects a subject from an input image, the control method comprising:
storage of storing, in a storage unit, a fixed model that is a non-changeable recognition model learned so as to detect a subject of a predetermined category and a custom model that is a customizable recognition model learned so as to detect a subject in an identical category to the fixed model;
setting of setting an integration method of a detection result using the fixed model and a detection result using the custom model; and
integration of acquiring an integration detection result by integrating, based on the integration method, each detection result to the input image.

17. A storage medium storing a program for causing a computer to execute a control method of an information processing apparatus that detects a subject from an input image, the control method comprising:
storage of storing, in a storage unit, a fixed model that is a non-changeable recognition model learned so as to detect a subject of a predetermined category and a custom model that is a customizable recognition model learned so as to detect a subject in an identical category to the fixed model;
setting of setting an integration method of a detection result using the fixed model and a detection result using the custom model; and
integration of acquiring an integration detection result by integrating, based on the integration method, each detection result to the input image.
